(19) United States
(12) Patent Application Publication
(10) Pub. No.: US 2026/0058311 A1
(43) Pub. Date: Feb. 26, 2026

(54) TAILORED SURFACE ELECTROLYTE INTERPHASE

(71) Applicant: GM Global Technology Operations LLC, Detroit, MI (US)

(72) Inventors: Jeffrey David Cain, Royal Oak, MI (US); Caleb Reese, Ferndale, MI (US); Nicholas Paul William Pieczonka, Troy, MI (US)

(73) Assignee: GM Global Technology Operations LLC, Detroit, MI (US)

(21) Appl. No.: 18/810,613

(22) Filed: Aug. 21, 2024

(51) Int. Cl. H01M 50/46; H01M 10/056

(52) U.S. Cl. CPC H01M 50/46; H01M 10/056; H01M 2220/20

(57) ABSTRACT

A battery comprising a separator, a conductive substrate, a negative electrode coupled to the conductive substrate and a surface electrolyte interphase (SEI) disposed between the separator and the negative electrode. The surface electrolyte interphase comprising a first layer coupled to and forming a first interface with the negative electrode, and a second layer coupled to the first layer and forming a second interface with the separator, the first layer being made of a first material and the second layer being made of a second material that is different than the first material.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to electroactive materials, and more particularly, to surface electrolyte interphase.

Advanced energy storage devices and systems are in demand to satisfy energy and/or power requirements for a variety of products, including automotive products such as start-stop systems (e.g., 12 V start-stop systems), battery-assisted systems, hybrid electric vehicles (“HEVs”), and electric vehicles (“EVs”). Typical batteries include at least two electrodes and an electrolyte and/or a separator. One of the two electrodes may serve as a positive electrode or cathode and the other electrode may serve as a negative electrode or anode. A separator filled with a liquid, solid, or semi-solid electrolyte may be disposed between the negative and positive electrodes. The electrolyte is suitable for conducting ions (e.g., lithium ions, calcium ions, sodium ions, and/or potassium ions) between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Conventional rechargeable batteries operate by reversibly passing the ions back and forth between the negative electrode and the positive electrode. For example, the ions may move from the positive electrode to the negative electrode during charging of the battery, and in the opposite direction when discharging the battery. Such batteries can reversibly supply power to an associated load device on demand. More specifically, electrical power can be supplied to a load device by the battery until the lithium, calcium, sodium, and/or potassium content of the negative electrode is effectively depleted. The battery may then be recharged by passing a suitable direct electrical current in the opposite direction between the electrodes.

During discharge, the negative electrode may contain a comparatively high concentration of intercalated lithium, calcium, sodium, and/or potassium, which is oxidized into lithium ions, calcium ions, sodium ions, and/or potassium ions releasing electrons. Lithium ions, calcium ions, sodium ions, and/or potassium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions, calcium ions, sodium ions, and/or potassium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

### SUMMARY

In one configuration, a battery is provided and includes a separator, a conductive substrate, a negative electrode coupled to the conductive substrate, and a surface electrolyte interphase (SEI) disposed between the separator and the negative electrode. The surface electrolyte interphase including a first layer coupled to and forming a first interface with the negative electrode, and a second layer coupled to the first layer and forming a second interface with the separator, the first layer being made of a first material and the second layer being made of a second material that is different than the first material.

The battery may include one or more of the following optional aspects. For example, the separator includes an electrolyte.

According to at least one aspect, the battery further includes a third interface between the first layer and the second layer. The first layer can be made of a first film that is configured to cling to a portion of the negative electrode and the second layer can be made of a second film that is configured to cling to a portion of the first film. The third interface can include interlocked portions of the first layer and the second layer.

According to another aspect, the first layer can have a first thickness and the second layer can have a second thickness that is substantially the same as the first thickness.

According to at least one example, the first layer can include an inorganic compound. The second layer can include an organic-rich compound.

According to another example, the first interface can include a first material that is chemically stable with respect to the negative electrode and the second interface can include a second material that is chemically stable with respect to the separator.

According to at least one aspect, the first layer and the second layer are both formed by a process including an in situ electrochemical reaction.

In another configuration, a battery is provided and includes a separator, a conductive substrate, a negative electrode coupled to the conductive substrate, and a surface electrolyte interphase (SEI) disposed between the separator and the negative electrode. The surface electrolyte interphase including a first interface with the negative electrode, a second interface with the separator, and a transition region arranged between the first interface and the second interface, the transition region including a first majority constituent of a first material near the first interface and a second majority constituent of a second material near the second interface.

The battery may include one or more of the following optional aspects. For example, the separator includes an electrolyte.

According to at least one aspect, the first material can include an inorganic compound. The second material can include an organic-rich compound.

According to another aspect, the surface electrolyte interphase includes a SEI thickness and the transition region includes a transition thickness that is about 20-50% of the SEI thickness.

In another configuration, a vehicle is provided and includes a vehicle body and one or more battery modules coupled to the vehicle body, the one or more battery modules each having one or more battery cells, the one or more battery cells each including a negative electrode, a positive electrode, a separator disposed between the negative electrode and the positive electrode, a first current collector positioned near the negative electrode opposite the separator, a second current collector positioned near the positive electrode opposite the separator, and a surface electrolyte interphase (SEI) disposed between the negative electrode and the separator. The surface electrolyte interphase including a first end arranged adjacent to and forming a first interface with the negative electrode, and a second end spaced from the first end and arranged adjacent to and forming a second interface with the positive electrode, the first interface includes a first majority constituent and the second interface includes a second majority constituent, the first majority constituent being different than the second majority constituent.

The vehicle may include one or more of the following optional aspects. For example, the first majority constituent can include an inorganic compound. The second majority constituent can include an organic-rich compound.

According to at least one aspect, the surface electrolyte interphase includes a third interface arranged between the first interface and the second interface, a first layer including the first majority constituent extending between the first interface and the third interface, and a second layer including the second majority constituent extending between the third interface and the second interface.

According to another aspect, the surface electrolyte interphase includes a transition region arranged between the first end and the second end, and the transition region generally includes equal parts of the first majority constituent and the second majority constituent.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle including a battery pack coupled to a motor according to principles of the present disclosure;

FIG. 2 is a perspective view of a battery module of the battery pack of FIG. 1 including one or more battery cells:

FIG. 3 is an illustration of one of the one or more battery cells of FIG. 2:

FIG. 4 is a fragmentary view of a first configuration of the battery cell of FIG. 3; and

FIG. 5 is a fragmentary view of a second configuration of the battery cell of FIG. 3.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a.” “an,” and “the” may be intended to include the plural forms as well, unless the context clearly indicates otherwise. The terms “comprises,” “comprising.” “including.” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on.” “engaged to.” “connected to,” “attached to.” or “coupled to” another element or layer, it may be directly on, engaged, connected, attached, or coupled to the other element or layer, or intervening elements or layers may be present. In contrast, when an element is referred to as being “directly on.” “directly engaged to.” “directly connected to,” “directly attached to,” or “directly coupled to” another element or layer, there may be no intervening elements or layers present. Other words used to describe the relationship between elements should be interpreted in a like fashion (e.g., “between” versus “directly between.” “adjacent” versus “directly adjacent,” etc.). As used herein, the term “and/or” includes any and all combinations of one or more of the associated listed items.

The terms “first.” “second.” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code: memory (shared, dedicated, or group) that stores code executed by a processor: other suitable hardware components that provide the described functionality: or a combination of some or all of the above, such as in a system-on-chip.

The term “code.” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app.” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a key board and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

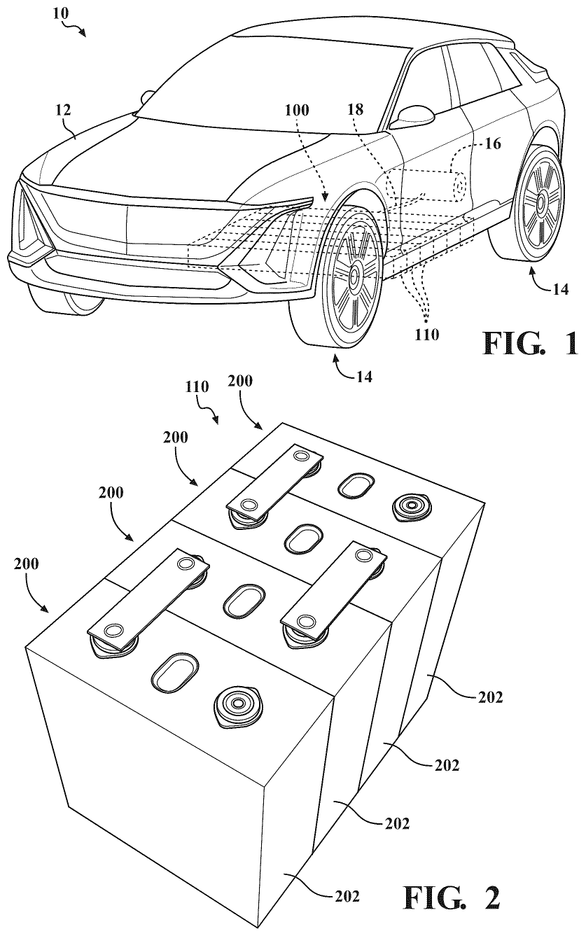

With reference to FIG. 1, an illustrative example of a vehicle 10, such as an electric motor vehicle, is provided. The vehicle 10, includes a vehicle body 12, one or more wheels 14, and an electric motor 16 arranged in and/or coupled to the vehicle body 12. The electric motor 16 can be configured to drive at least one of the one or more wheels 14 to propel the vehicle 10. The vehicle 10 includes a battery pack 100 that can be arranged in and/or coupled to the vehicle body 12 and is communicatively coupled to the electric motor 16 via an electric power cable 18.

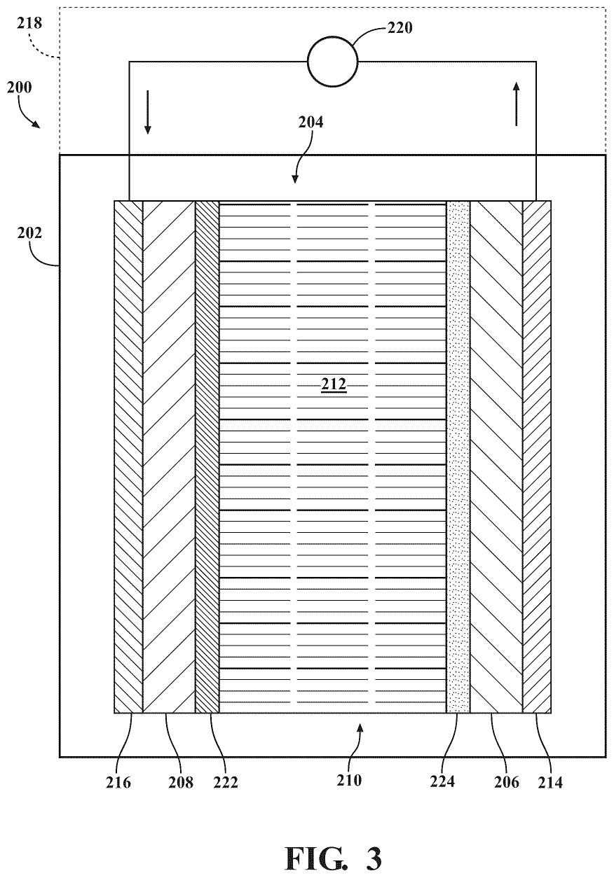

The battery pack 100 can have one or more battery modules 110 that each includes one or more battery cells 200 (FIG. 2). The one or more battery cells 200 can be prismatic battery cells, as shown in FIG. 2. However, the principles of the present disclosure equally apply to other types of battery cells (e.g., pouch cells, cylindrical cells, etc.) as well. The one or more battery cells 200 each includes a main body 202 (e.g., a prismatic can) that is configured to house battery cell internals (FIG. 3) 204.

With reference to FIG. 3, each of the one or more battery cells 200 includes a negative electrode 206 (e.g., anode), a positive electrode 208 (e.g., cathode), and a separator 210 disposed between the negative electrode 206 and the positive electrode 208. The separator 210 provides electrical separation-prevents physical contact-between the electrodes 206, 208. The separator 210 also provides a minimal resistance path for internal passage of lithium ions, and in certain instances, related anions, during cycling of the lithium ions. The separator 210 may be in a solid and/or a liquid form and/or a hybrid thereof. For example, in certain variations, the separator 210 may include an electrolyte 212. In certain variations, the separator 210 may be formed by a solid-state electrolyte or a semi-solid-state electrolyte (e.g., gel electrolyte). For example, the separator 210) may include a plurality of solid-state electrolyte particles and/or a gel electrode.

A first current collector 214 (e.g., a negative current collector) may be positioned at or near the negative electrode (which can also be referred to as a negative conductive substrate) 206. The first current collector 214 together with the negative electrode 206 may be referred to as a negative electrode assembly. Although not illustrated, in certain variations, negative electroactive material layers may be disposed on one or more parallel sides of the first current collector 214. Similarly, in other variations, a negative electroactive material layer may be disposed on a first side of the first current collector 214, and a positive electroactive material layer may be disposed on a second side of the first current collector 214. In each instance, the first current collector 214 may be a metal foil, metal grid or screen, or expanded metal comprising copper or any other appropriate electrically conductive material known to those of skill in the art.

A second current collector 216 (e.g., a positive current collector) may be positioned at or near the positive electrode (which can also be referred to as a positive conductive substrate) 208. The second current collector 216 together with the positive electrode 208 may be referred to as a positive electrode assembly. Although not illustrated, in certain variations, a positive electroactive material layer may be disposed on one or more parallel sides of the second current collector 216. Similarly, in other variations, a positive electroactive material layer may be disposed on a first side of the second current collector 216, and a negative electroactive material layer may be disposed on a second side of the second current collector 216. In each instance, the second current collector 216 may be a metal foil, metal grid or screen, or expanded metal comprising aluminum or any other appropriate electrically conductive material known to those of skill in the art.

The first current collector 214 and the second current collector 216 may respectively collect and move free electrons to and from an external circuit 218. For example, an interruptible external circuit 218 and a load device 220 may connect the negative electrode 206 (through the first current collector 214) and the positive electrode 208 (through the second current collector 216). The battery 20 can generate an electric current during discharge by way of reversible electrochemical reactions that occur when the external circuit 218 is closed (to connect the negative electrode 206 and the positive electrode 208) and the negative electrode 206 has a lower potential than the positive electrode. The chemical potential difference between the positive electrode 208 and the negative electrode 206 drives electrons produced by a reaction, for example, the oxidation of intercalated lithium, at the negative electrode 206 through the external circuit 40 toward the positive electrode 208. Lithium ions that are also produced at the negative electrode 206 are concurrently transferred through the electrolyte 212 contained in the separator 210 toward the positive electrode 208. The electrons flow through the external circuit 218 and the lithium ions migrate across the separator 210 containing the electrolyte 212 to form intercalated lithium at the positive electrode 208. The electric current passing through the external circuit 40) can be harnessed and directed through the load device 220 until the lithium in the negative electrode 206 is depleted and the capacity of the one or more battery cells 200 is diminished.

With continued reference to FIG. 3, each of the one or more battery cells 200 can optionally include a cathode electrolyte interphase (CEI) 222 arranged between the separator 210 (i.e., the electrolyte 212) and the positive electrode 208. The CEI 222 can be coupled to and/or arranged on the positive electrode 208. The CEI 222 may be desirable to enhance stability and/or performance of the one or more battery cells 200, for example.

Each of the one or more battery cells 200 includes a surface electrolyte interphase (SEI) 224 arranged between the separator 210 (i.e., the electrolyte 212) and the negative electrode 206. The SEI 224 is coupled to and/or arranged on the negative electrode 206. For instance, the SEI 224 can be coupled to the surface of the negative electrode 206 and/or at least partially embedded into the negative electrode 206. The interrelation between the SEI 224 and the negative electrode 206 can be examined using x-ray photoelectron spectroscopy (XPS) depth profiling, for example. As will be discussed in more detail below, the structure of the SEI 224 can be controlled and/or tailored using a process involving an in situ electrochemical reaction. In general, it can be desirable for the SEI 224 to have high chemical stability, high ionic conductivity, low thickness to decrease ion diffusion resistance, and/or a high modulus of elasticity and mechanical strength to suppress dendrite growth and fracture. Heretofore, SEI is generally monolithic and its components commonly have a high modulus of elasticity but low ionic conductivity (e.g., lithium floride (LiF)) or have high flexibility but a low modulus of elasticity (e.g., lithium carboxylate (LiCO₂CF₃)).

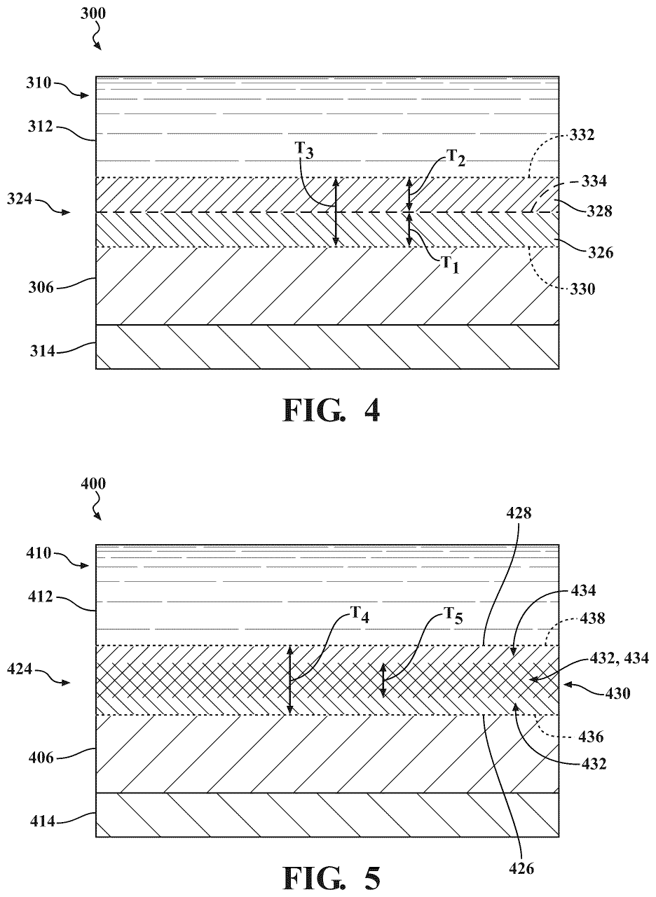

FIG. 4 illustrates an illustrative configuration of a battery 300 including a multilayer SEI 324. This configuration is similar in many respects to the configuration of FIGS. 1-3. Accordingly, the descriptions of the configurations are hereby incorporated into one another, and description of subject matter common to the configurations generally may not be repeated.

With reference to FIG. 4, the multilayer SEI 324 is disposed between a separator 310 (i.e., an electrolyte 312) and a negative electrode 306. In the present illustrative example, the multilayer SEI 324 includes a first layer 326 and a second layer 328. The first layer 326 can be coupled to and/or arranged on the negative electrode 306 and the second layer 328 is coupled to and/or arranged on the first layer 326, as shown in FIG. 4. According to one aspect, the first layer 326 can be at least partially coupled to (i.e., embedded into, interlocked with, etc.) the negative electrode 306 so that the negative electrode 306 is sandwiched between the first layer 326 and a first current collector 314 (e.g., a negative current collector). Additionally or alternatively, the second layer 328 can be at least partially coupled to (i.e., embedded into, interlocked with, etc.) the first layer 326 so that the first layer 326 is sandwiched between the second layer 328 and the negative electrode 306. The first layer 326 can be made of a first film that is configured to cling to a portion of the negative electrode 306 and the second layer 328 can be made of a second film that is configured to cling to a portion of the first film. The interrelation between the first layer 326 and the negative electrode 306 and/or the first layer 326 and the second layer 328 can be examined using x-ray photoelectron spectroscopy (XPS) depth profiling, for example.

According to one aspect, the first layer 326 can have a first thickness T₁ and the second layer 328 can have a second thickness T₂, and together the first thickness T₁ and second thickness T₂ define a thickness T₃ of the multilayer SEI 324. The thickness T₃ of the multilayer SEI 324 can be between 1 nm and 150 nm and, preferably, between 10 nm and 50 nm. In the present illustrative configuration, the first thickness T₁ is substantially the same as the second thickness T₂. However, in a least one example, the first thickness T₁ can be thicker or thinner than the second thickness T₂.

The battery 300 includes a first interface 330 between the first layer 326 and the negative electrode 306 and a second interface 332 between the second layer 328 and the separator 310 (i.e., electrolyte 312). Optionally, a third interface 334 can be arranged and defined between the first layer 326 and the second layer 328. The third interface 334 can include a boundary where the first layer 326 ends and the second layer 328 begins. Control of a formation protocol (i.e., voltage, current density/rate, additive timing, etc.) in conjunction with selecting various electrolytes and/or additives can be desirable for forming the first interface 330, the second interface 332, and/or the third interface 334 for specific purposes. According to at least one aspect, the multilayer SEI 324 and, more particularly, the first layer 326 and/or the second layer 328, can be controlled and/or tailored using a process involving an in situ electrochemical reaction. According to another aspect, the first interface 330 can include a first majority constituent and the second interface 332 can include a second majority constituent. The first majority constituent can be different than the second majority constituent.

The first layer 326 can be made of a first material and the second layer 328 can be made of a second material that is different than the first material. The first material can be a hard or inorganic-rich compound that is chemically stable against the material of the negative electrode (e.g., lithium metal). For instance, the first material can be made of lithium fluoride (LiF) or lithium oxide (Li₂O). The second material can be a soft (i.e., flexible) or organic-rich compound that is chemically stable against the separator 310 (i.e., the electrolyte 312). For example, the second material may be made of lithium trifluoroacetate (LiCO₂CF₃). According to one aspect, the first material can be the first majority constituent at the first interface 330 and the second material can be the second majority constituent at the second interface 332.

FIG. 5 illustrates another illustrative configuration of a battery 400 including a graded SEI 424. This configuration is similar in many respects to the configurations of FIGS. 1-3 and FIG. 4. Accordingly, the descriptions of the configurations are hereby incorporated into one another, and description of subject matter common to the configurations generally may not be repeated.

With reference to FIG. 5, the graded SEI 424 is disposed between a separator 410 (i.e., an electrolyte 412) and a negative electrode 406. In the present illustrative example, the graded SEI 424 includes a first end 426, a second end 428 spaced from the first end 426, and a transition region 430 arranged between the first end 426 and the second end 428. The first end 426 can be coupled to and/or arranged on the negative electrode 406. According to one aspect, the first end 426 can be at least partially embedded into (i.e., interlocked with) the negative electrode 406. As shown in FIG. 5, the negative electrode 406 is sandwiched between the graded SEI 424 and a first current collector 414 (e.g., a negative current collector). According to one aspect, the graded SEI 424 can have a SEI thickness T₄ that extends between the first end 426 and the second end 428. The transition region 430 can have a transition thickness T₅ that is between 20-50% of the SEI thickness T₄.

The graded SEI 424 can include two or more materials that vary in weight percentage between the first end 426 and the second end 428. In the present illustrative example, the graded SEI 424 includes a first material 432 and a second material 434 that is different than the first material 432. In general, the first material 432 can be a hard and/or inorganic-rich material that is stable with respect to the material of the negative electrode 406 (e.g., lithium metal). The second material 434 can be a soft and/or organic-rich material that is stable with respect to the material of the separator 410 (i.e., the electrolyte 412). In the present illustrative example, the transition region 430 includes at least some of both the first material 432 and the second material 434. In other words, the weight percentage of the first material 432 and the weight percentage of the second material 434 is about equal to each other within the transition region 430. The weight percentage of the first material 432 gradually increases while the weight percentage of the second material 434 gradually decreases toward the first end 426. Likewise, the weight percentage of the second material 434 gradually increases and the weight percentage of the first material 432 gradually decreases toward the second end 428. Stated differently, a first interface 436 can be defined between the graded SEI 424 and the negative electrode 406 such that the first interface 436 includes material of the negative electrode and the first material 432. According to one aspect, the first material 432 can be a first majority constituent of the graded SEI 424 at the first interface 436. Likewise, a second interface 438 can be defined between the graded SEI and the separator 410 (i.e., the electrolyte 412) such that the second interface 438 includes material of the electrolyte 412 and the second material 434. According to one aspect, the second material 434 can be a second majority constituent of the graded SEI 424 at the second interface 438.

The interrelation between the first end 426 and the negative electrode 406, between the first material 432 and the second material 434 within the transition region 430, and/or between the second end 428 and the separator 410 can be examined using x-ray photoelectron spectroscopy (XPS) depth profiling, for example. In contrast to the previous configuration, the transition region 430 can be configured such that it does not include a definitive boundary between the first material 432 and the second material 434.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery, comprising:
a separator;
a conductive substrate;
a negative electrode coupled to the conductive substrate; and
a surface electrolyte interphase (SEI) disposed between the separator and the negative electrode, comprising:
a first layer coupled to and forming a first interface with the negative electrode, and
a second layer coupled to the first layer and forming a second interface with the separator, the first layer being made of a first material and the second layer being made of a second material that is different than the first material.

2. The battery of claim 1, wherein the separator includes an electrolyte.

3. The battery of claim 1, further comprising a third interface between the first layer and the second layer.

4. The battery of claim 3, wherein first layer is made of a first film that is configured to cling to a portion of the negative electrode and the second layer is made of a second film that is configured to cling to a portion of the first film.

5. The battery of claim 3, wherein the third interface includes interlocked portions of the first layer and the second layer.

6. The battery of claim 1, wherein the first layer has a first thickness and the second layer has a second thickness that is substantially the same as the first thickness.

7. The battery of claim 1, wherein the first layer includes an inorganic compound.

8. The battery of claim 7, wherein the second layer includes an organic-rich compound.

9. The battery of claim 1, wherein the first interface includes a first material that is chemically stable with respect to the negative electrode and the second interface includes a second material that is chemically stable with respect to the separator.

10. The battery of claim 1, wherein the first layer and the second layer are both formed by a process comprising an in situ electrochemical reaction.

11. A battery, comprising:
a separator;
a conductive substrate;
a negative electrode coupled to the conductive substrate; and
a surface electrolyte interphase (SEI) disposed between the separator and the negative electrode, comprising:
a first interface with the negative electrode,
a second interface with the separator, and
a transition region arranged between the first interface and the second interface, the transition region including a first majority constituent of a first material near the first interface and a second majority constituent of a second material near the second interface.

12. The battery of claim 11, wherein the separator includes an electrolyte.

13. The battery of claim 12, wherein the first material includes an inorganic compound.

14. The battery of claim 13, wherein the second material includes an organic-rich compound.

15. The battery of claim 11, wherein the surface electrolyte interphase includes a SEI thickness and the transition region includes a transition thickness that is about 20-50% of the SEI thickness.

16. A vehicle, comprising:
a vehicle body; and
one or more battery modules coupled to the vehicle body, the one or more battery modules each having one or more battery cells, the one or more battery cells each comprising:
a negative electrode,
a positive electrode,
a separator disposed between the negative electrode and the positive electrode,
a first current collector positioned near the negative electrode opposite the separator,
a second current collector positioned near the positive electrode opposite the separator, and
a surface electrolyte interphase (SEI) disposed between the negative electrode and the separator, comprising:
a first end arranged adjacent to and forming a first interface with the negative electrode, and
a second end spaced from the first end and arranged adjacent to and forming a second interface with the positive electrode, the first interface includes a first majority constituent and the second interface includes a second majority constituent, the first majority constituent being different than the second majority constituent.

17. The vehicle of claim 16, wherein the first majority constituent includes an inorganic compound.

18. The vehicle of claim 17, wherein the second majority constituent includes an organic-rich compound.

19. The vehicle of claim 16, wherein the surface electrolyte interphase includes a third interface arranged between the first interface and the second interface, a first layer including the first majority constituent extending between the first interface and the third interface, and a second layer including the second majority constituent extending between the third interface and the second interface.

20. The vehicle of claim 16, wherein the surface electrolyte interphase includes a transition region arranged between the first end and the second end, and the transition region generally includes equal parts of the first majority constituent and the second majority constituent.
